(19) United States
(12) Patent Application Publication
(10) Pub. No.: US 2018/0012292 A1
(43) Pub. Date: Jan. 11, 2018

(54) INFORMATION PROCESSING APPARATUS, INFORMATION PROCESSING METHOD, AND COMPUTER READABLE STORAGE MEDIUM

(71) Applicant: FUJITSU LIMITED, Kawasaki-shi (JP)

(72) Inventors: Shigeki SUGIYAMA, Hamamatsu (JP); Mitsuo Ando, Numadu (JP); Hitoshi Owaki, Susono (JP); Naoki Gunji, Numadu (JP)

(73) Assignee: FUJITSU LIMITED, Kawasaki-shi (JP)

(21) Appl. No.: 15/643,655

(22) Filed: Jul. 7, 2017

(30) Foreign Application Priority Data
Jul. 8, 2016 (JP) 2016-136072

(51) Int. Cl. G06Q 30/06; G06Q 30/04

(52) U.S. Cl. CPC G06Q 30/0645; G06Q 30/04

(57) ABSTRACT

An information processing apparatus including: a memory configured to store information associating, for each project of one or more projects having a flat structure, the project with an organization that is selected from a plurality of organizations having a hierarchical structure, at least one of one or more members of the project belonging to the selected organization, and a processor coupled to the memory and the processor configured to: charge, when a first service is provided for a first project, a first organization for the provided first service, the first organization being associated with the first project by the stored information.

### CROSS-REFERENCE TO RELATED APPLICATION

This application is based upon and claims the benefit of priority of the prior Japanese Patent Application No. 2016-136072, filed on Jul. 8, 2016, the entire contents of which are incorporated herein by reference.

### FIELD

Embodiments discussed herein are related to an information processing apparatus, an information processing method, and an information processing system.

### BACKGROUND

If a service is provided to branches of a company or affiliated companies, the charge is made to the branches which use the service based on the number of users.

Japanese Laid-open Patent Publication No. 2016-103284 discloses a related technique.

### SUMMARY

According to an aspect of the embodiments, an information processing apparatus includes a memory configured to store information associating, for each project of one or more projects having a flat structure, the project with an organization that is selected from a plurality of organizations having a hierarchical structure, at least one of one or more members of the project belonging to the selected organization, and a processor coupled to the memory and the processor configured to: charge, when a first service is provided for a first project, a first organization for the provided first service, the first organization being associated with the first project by the stored information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an organization and examples of projects;

FIG. 2 illustrates an example of a functional configuration of a charging management apparatus;

FIG. 3 illustrates an example of an employee table;

FIG. 4 illustrates an example of an organization table;

FIG. 5 illustrates an example of a charging management apparatus;

FIG. 6 illustrates an example of a project table;

FIGS. 7A and 7B illustrate examples of service use information tables;

FIG. 8 illustrates an example of a unit-price table;

FIG. 9 illustrates an example of a log-in screen;

FIG. 10 illustrates an example of a project creating process;

FIG. 11 illustrates an example of a charging process; and

FIG. 12 illustrates an example of a hardware configuration of a computer.

### DESCRIPTION OF EMBODIMENT

If charging is performed based on the number of users, the users may become less aware of the cost, which may lead to, for example, the use of a service in an unnecessarily great amount. For example, if a software development branch uses a service for lending computer resources, unnecessarily large computer resources may be held over an unnecessarily long period, and a waste of computer resources may occur.

In order to suppress such a waste, it is possible to perform pay-per-use charging in accordance with the amount of a service that has been used. In the pay-per-use charging, the amount of a service used by each organization is regularly measured, and the organization is charged in accordance with the amount.

For example, if the charge of a physical resource in accordance with the usage amount of the physical resource that a virtual machine has used for a predetermined period is higher than a predetermined limit, based on contents of a memory that stores the charge of the physical resource or profits corresponding to the charge of the physical resource, the physical resource to be assigned to the virtual machine is reduced.

However, a simple method, with which an organization of an user is charged for a service used by the user, does not enable to select a payer for the used service flexibly.

An object of the disclosed technology is to provide an information processing apparatus, an information processing method, and an information processing system which enable to select a payer for the used service flexibly.

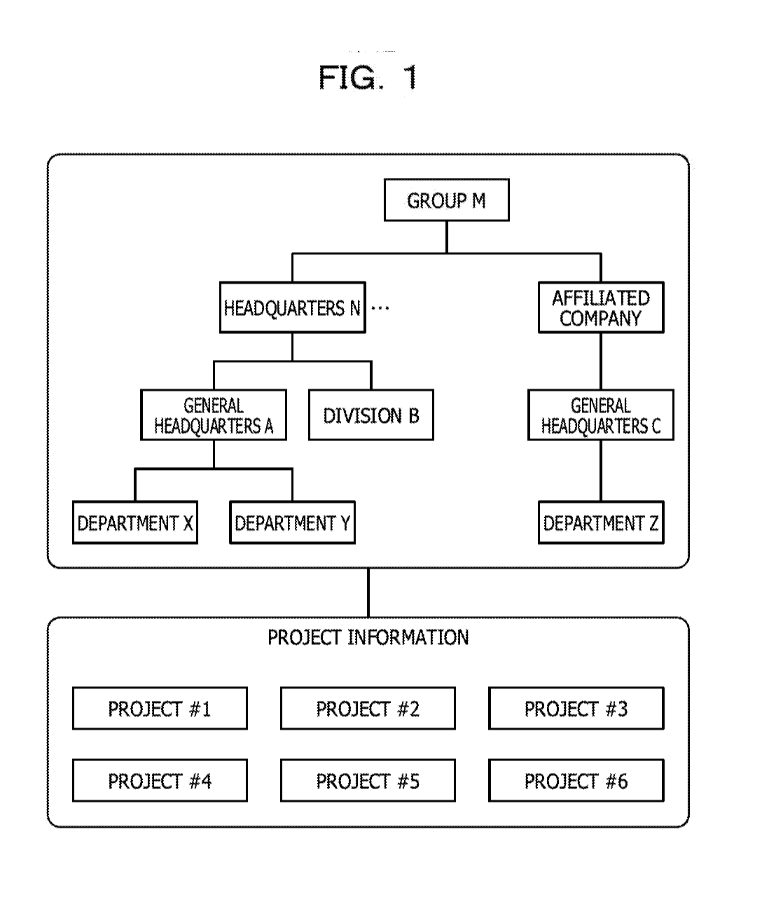

The target to be charged instead of an organization is, for example, a project. FIG. 1 illustrates an example of an organization and examples of projects. As illustrated in FIG. 1, for example, an organization called Group M consists of a plurality of headquarters including Headquarters N and an affiliated company, General Headquarters A and Division B are under Headquarters N, and Department X and Department Y are under General Headquarters A. The organization has a hierarchical structure in this manner.

The projects have a flat structure unlike the organization. In FIG. 1, Project #1 to Project #6 are provided independently of the hierarchical organization called Group M. Each project is associated with project members who belong to the project and an office organization code.

The office organization code is a code associated with the payer of charges. The charge of a service that a project member or project members have used is paid by the organization associated with the office organization code. Even if a change is made in the organization, the association between the office organization code and the project remains. The office organization code is changed less frequently than the organization.

By associating the user or users of the service and the payer of the charge by means of a project in the above manner, for example, the payer of the charge is not corrected frequently as a result of a change in the organization.

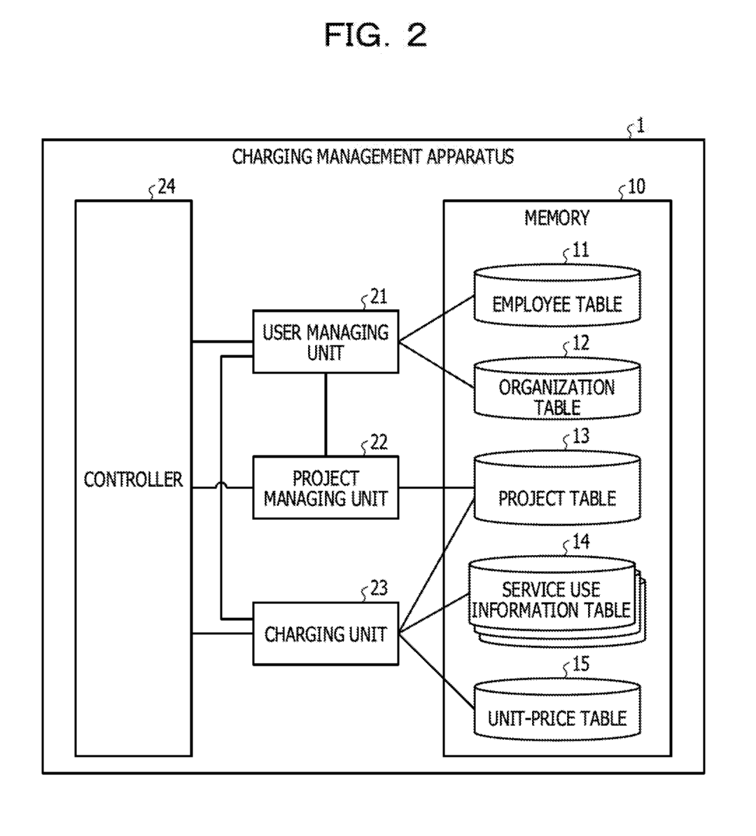

FIG. 2 illustrates an example of a functional configuration of a charging management apparatus. As illustrated in FIG. 2, a charging management apparatus 1 includes a memory 10, a user managing unit 21, a project managing unit 22, a charging unit 23, and a control unit 24.

The memory 10 stores an employee table 11, an organization table 12, a project table 13, a service use information table 14, and a unit-price table 15.

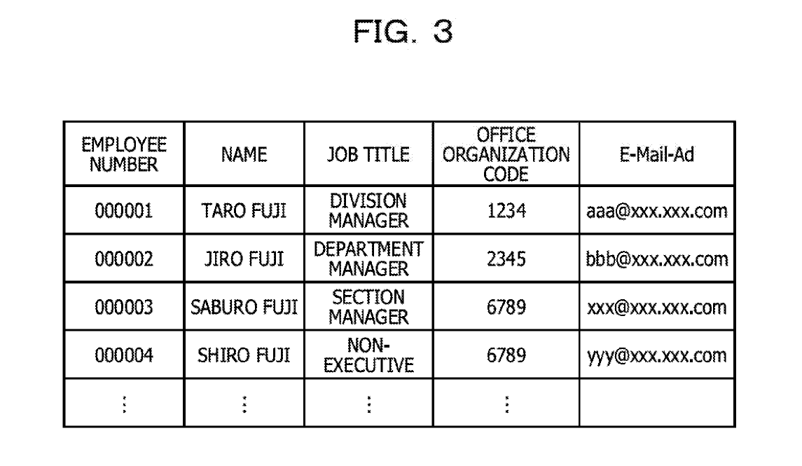

The employee table 11 is a table in which information regarding employees is registered. FIG. 3 illustrates an example of an employee table. As illustrated in FIG. 3, in the employee table 11, the employee number, the name, the job title, the office organization code, and E-Mail-Ad are associated with one another.

The employee number is the number for identifying an employee. The name is the name of the employee. The job title indicates the position or role of the employee in the organization. The office organization code is a code associated with the organization to which the employee belongs. E-Mail-Ad is a mail address of the employee.

For example, the name of an employee with an employee number of “000001” is “TARO FUJI”, whose job title is “DIVISION MANAGER”, whose office organization code is “1234”, and whose E-Mail-Ad is “aaa@xxx.xxx.com”.

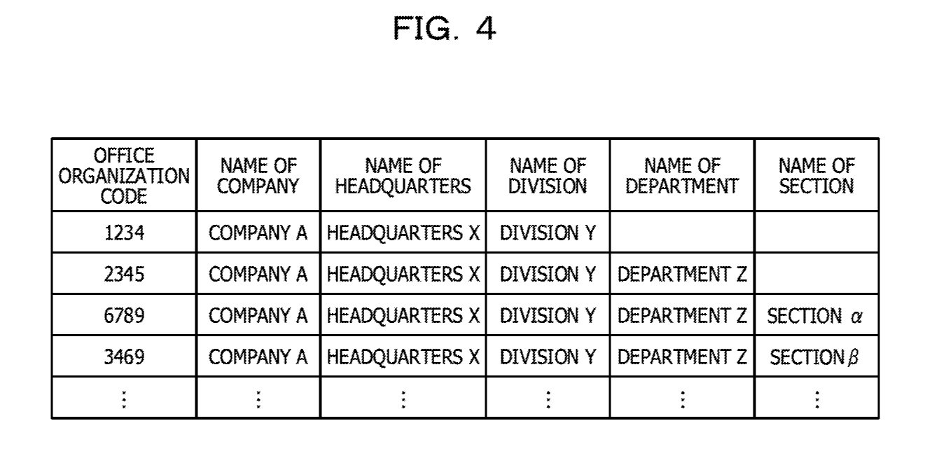

The organization table 12 is a table that indicates the hierarchical structure of the organization, in which the organization and the office organization code are associated to each other. FIG. 4 illustrates an example of an organization table. As illustrated in FIG. 4, in the organization table 12, the office organization code and the organization are associated with each other. The organization table 12 indicates the hierarchical structure of the organization by means of the name of a company, the name of headquarters, the name of a division, the name of a department, and the name of a section.

For example, “Company A”, “Headquarters X”, “Division Y”, “Department Z”, and “Section α” corresponds to an office organization code of “6789”. “Section α” and “Section β” belong to “Department Z”, “Department Z” belongs to “Division Y”, “Division Y” belongs to “Headquarters X”, and “Headquarters X” belongs to “Company A”.

The employee table 11 and the organization table 12 are updated by another information processing system, and the charging management apparatus 1 stores, in the memory 10, the employee table 11 and the organization table 12 updated by the other information processing system to use the employee table 11 and the organization table 12.

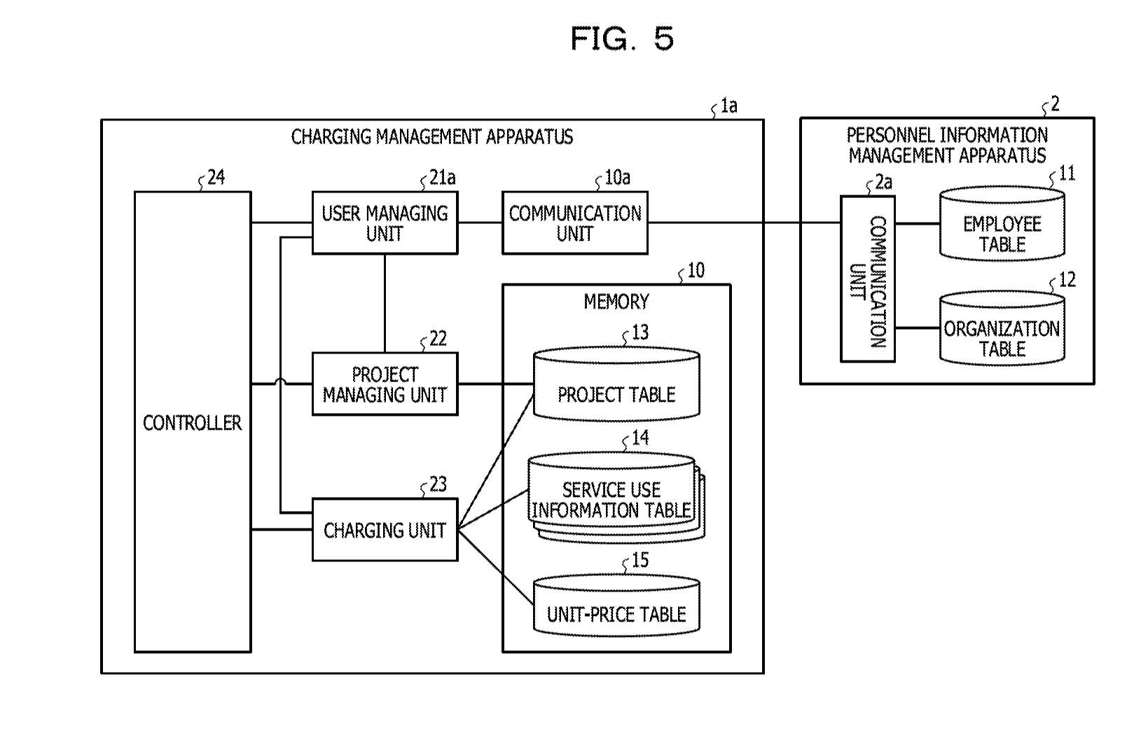

The charging management apparatus may receive and use information of the employee table 11 and the organization table 12 from another information processing apparatus that stores and updates the employee table 11 and the organization table 12. FIG. 5 illustrates an example of a charging management apparatus. For example, a charging management apparatus 1a illustrated in FIG. 5 receives and uses information of the employee table 11 and the organization table 12 from another information processing apparatus.

As illustrated in FIG. 5, a personnel information management apparatus 2 stores the employee table 11 and the organization table 12. The personnel information management apparatus 2 includes a communication unit 2a, and the communication unit 2a transmits information of the employee table 11 and the organization table 12 to the charging management apparatus 1a. The charging management apparatus 1a includes a communication unit 10a, and the communication unit 10a receives the information of the employee table 11 and the organization table 12 from the personnel information management apparatus 2 and provides the information to a user managing unit 21a.

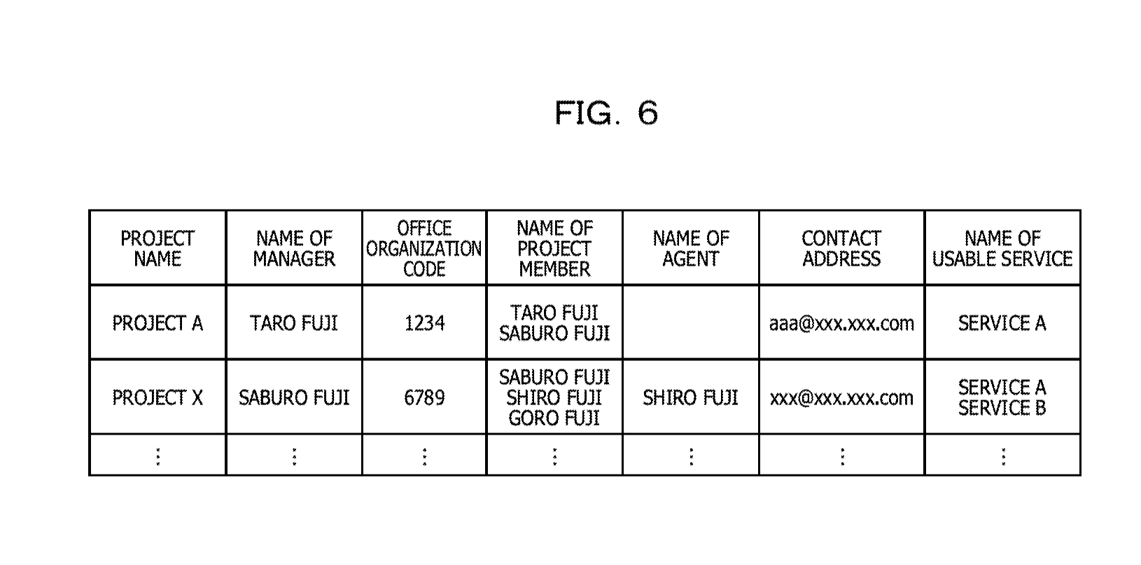

The project table 13 is a table in which information regarding a project is registered. FIG. 6 illustrates an example of a project table. As illustrated in FIG. 6, in the project table 13, the project name, the name of a manager, the office organization code, the name of a project member, the name of an agent, the contact address, and the name of a usable service are associated with one another.

The project name is the name for identifying a project. The name of a manager is the name of a person who is responsible for the project. The office organization code is the office organization code of the payer of the charge. The name of a project member is the name of a member who belongs to the project. The name of an agent is the name of an agent who plays the role of the manager if the manager is absent. The contact address is a mail address of the manager. The name of a usable service is the name of a service that may be used by the project.

For example, in a project with a project name of “Project A”, the name of a manager is “TARO FUJI”, the office organization code of the payer of the charge is “1234”, and the names of project members are “TARO FUJI” and “SABURO FUJI”. The mail address of the manager is “aaa@xxx.xxx.com”, and the name of a usable service is “Service A”.

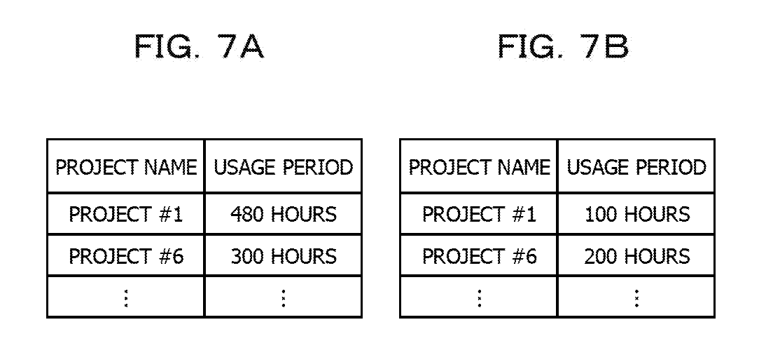

The service use information table 14 is a table in which information regarding the use of a service is registered. FIGS. 7A and 7B illustrate examples of service use information tables. In FIGS. 7A and 7B, the service use information table 14 is provided for each service. FIG. 7A illustrates the service use information table 14 for Service A, and FIG. 7B illustrates the service use information table 14 for Service B.

As illustrated in FIGS. 7A and 7B, in each of the service use information tables 14, the project name and the usage period are associated with each other. The project name is the name of a project that has used a service. The usage period is the monthly sum total periods of using the service. For example, a project with a name of “Project #1” uses Service A for 480 hours this month.

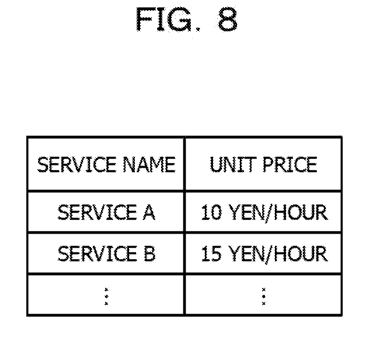

The unit-price table 15 is a table in which the usage price of a service per unit of hours is registered. FIG. 8 illustrates an example of a unit-price table. As illustrated in FIG. 8, in the unit-price table 15, the service name and the unit price are associated with each other.

The unit price is the price of a service used for a unit of hours and is, in this case, the price of a service used for one hour. For example, the usage price of a service with a name of “Service A” per hour is “10 yen”.

Referring back to FIG. 2, the user managing unit 21 manages information regarding users of the service. Based on instructions from the project managing unit 22, the user managing unit 21, for example, acquires information from the employee table 11 and the organization table 12 stored in the memory 10. Based on an instruction from the charging unit 23, the user managing unit 21 acquires information from the organization table 12. The user managing unit 21a illustrated in FIG. 5 acquires information of the employee table 11 and the organization table 12 from the personnel information management apparatus 2 through the communication unit 10a.

The project managing unit 22 manages a project. For example, based on an instruction of a manager of the project, the project managing unit 22 creates a project and registers information regarding the created project in the project table 13.

Based on instructions of the manager of the project and an agent, the project managing unit 22 corrects information regarding the project and updates the project table 13. For example, the office organization code in the project table 13 may be changed only by the manager.

If information regarding the project is corrected based on an instruction from the agent, the project managing unit 22 allows the manager to confirm the corrected content. If the manager's approval is not obtained, the project managing unit 22 notifies the agent of this fact.

If a user logs in to the charging management apparatus 1, the project managing unit 22 acquires information regarding the user from the user managing unit 21 and acquires information regarding the project from the project table 13. Based on the acquired information, the project managing unit 22 creates a log-in screen and displays the log-in screen on a display apparatus.

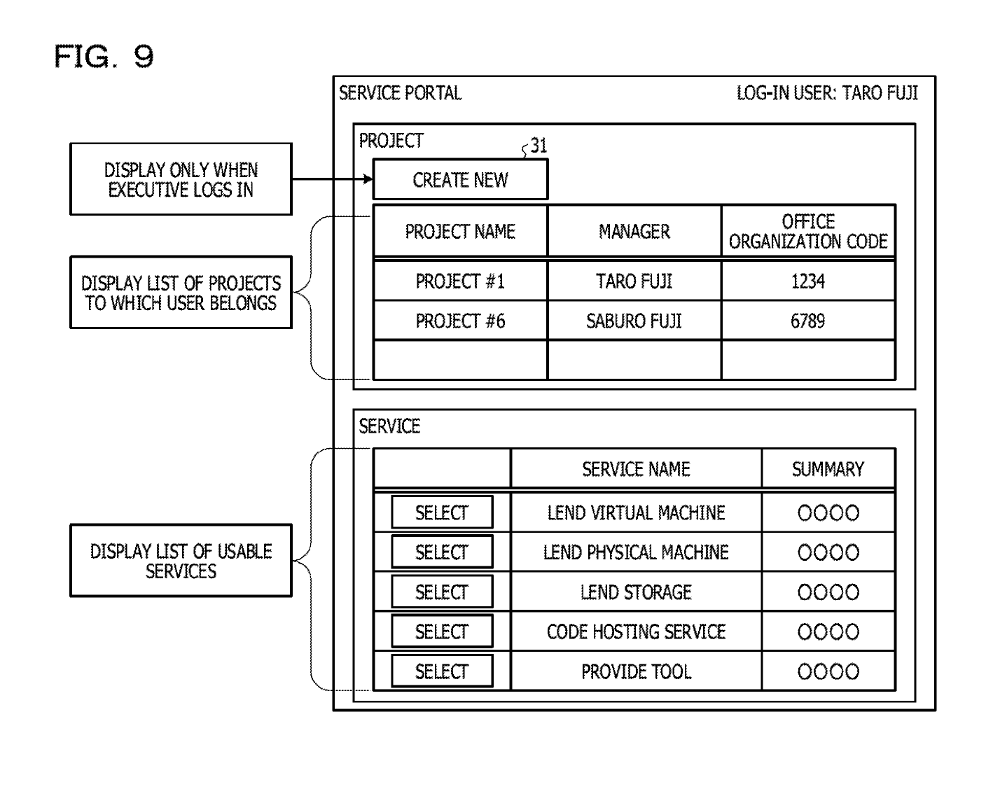

FIG. 9 illustrates an example of the log-in screen. As illustrated in FIG. 9, a list of projects to which the logged-in user belongs and a list of services that are usable by the logged-in user are displayed on the log-in screen. If the logged-in user is an executive, a new creation button 31 for starting a function of newly creating a project is displayed on the log-in screen. Here, the executive may be a section manager or an executive higher than the section manager.

The charging unit 23 manages service usage periods for each project and registers the monthly sum total usage periods in the service use information table 14. The charging unit 23 confirms a monthly usage amount on a predetermined day each month and calculates the charge occurred for each project by referring to the service use information table 14 and the unit-price table 15.

The charging unit 23 identifies the office organization code associated with the project by referring to the project table 13. The charging unit 23 identifies the organization associated with the office organization code by referring to the organization table 12 and charges the identified organization.

The control unit 24 controls the whole of the charging management apparatus 1 and transfers control between the functional units, for example, so as to make the charging management apparatus 1 function as one apparatus.

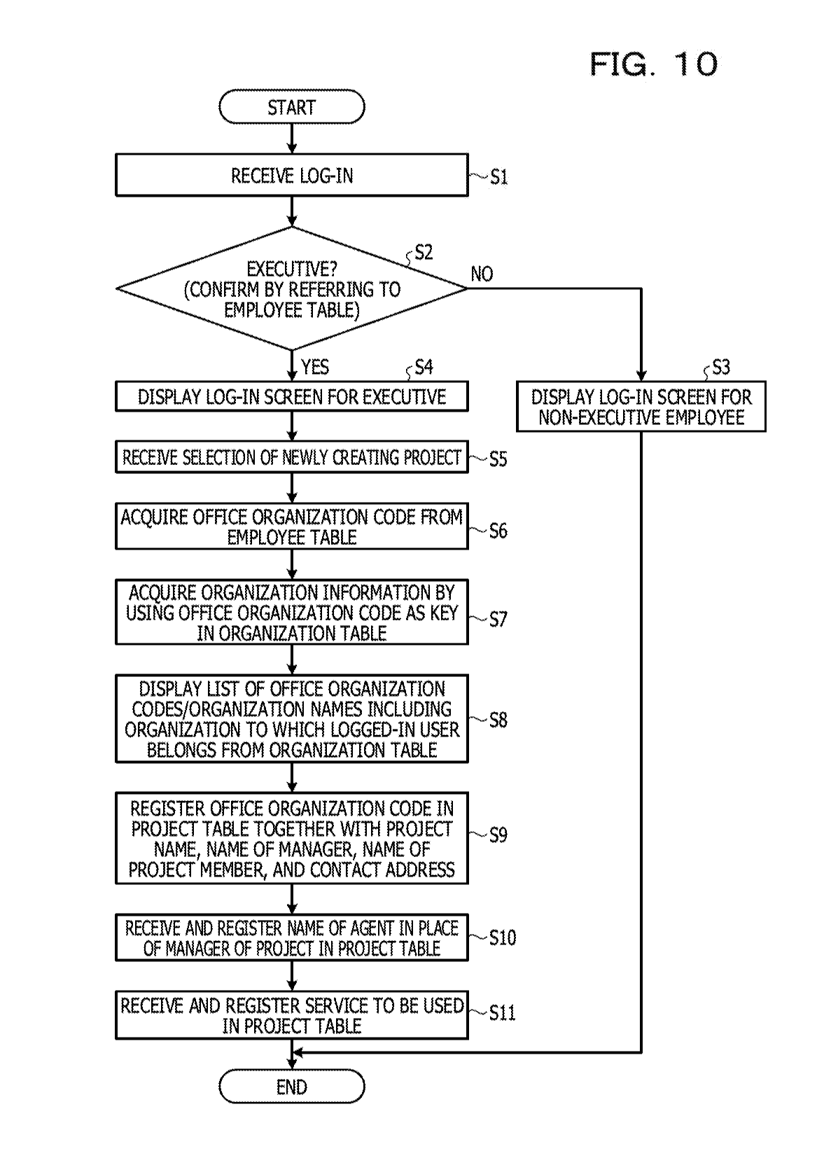

Next, the flow of a project creating process will be described. FIG. 10 illustrates an example of the project creating process. As illustrated in FIG. 10, the project managing unit 22 receives log-in of a user (operation S1) and determines whether or not the logged-in user is an executive by referring to the employee table 11 (operation S2).

If the logged-in user is not an executive, a log-in screen for a non-executive employee is displayed (operation S3). The log-in screen for a non-executive employee may be, for example, the log-in screen illustrated in FIG. 9 from which the new creation button 31 is deleted.

If the logged-in user is an executive, the project managing unit 22 displays a log-in screen for an executive (operation S4) and receives selection of newly creating a project from the logged-in user (operation S5). The project managing unit 22 acquires the office organization code of the logged-in user from the employee table 11 (operation S6) and acquires organization information by using the office organization code as a key in the organization table 12 (operation S7).

The project managing unit 22 displays, from the organization table 12, a list of office organization codes/organization names including an organization to which the logged-in user belongs (operation S8). For example, in FIG. 4, if the office organization code is “1234”, a list of “1234/Company A Headquarters X Division Y”, “2345/Company A Headquarters X Division Y Department Z”, “6789/Company A Headquarters X Division Y Department Z Section α”, and “3469/Company A Headquarters X Division Y Department Z Section β” are displayed. If the office organization code is “6789”, only “6789/Company A Headquarters X Division Y Department Z Section α” is displayed.

The project managing unit 22 registers the office organization code selected by the logged-in user in the project table 13 together with the project name, the name of a manager, the name of a project member, and the contact address (operation S9). The project managing unit 22 receives and registers the name of an agent in the project table 13 (operation S10), and receives and registers the name of a usable service in the project table 13 (operation S11).

Since the project managing unit 22 registers the office organization code in the project table 13 in association with the project in the above manner, the charging management apparatus 1 may charge an organization associated with the office organization code for using a service.

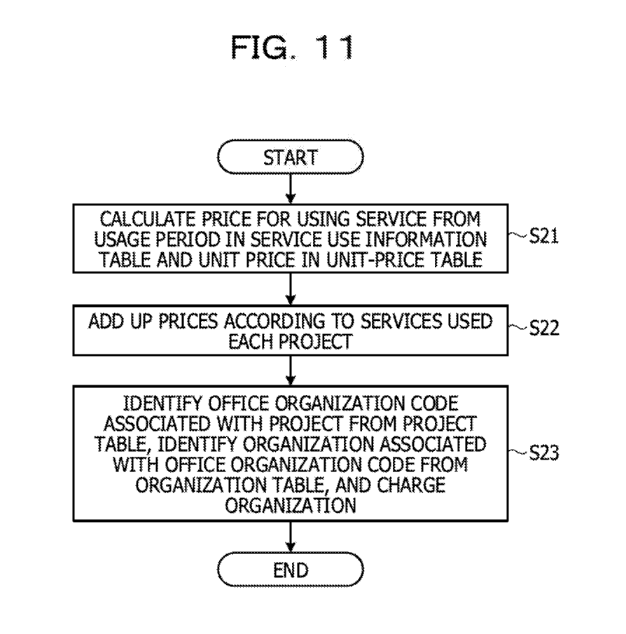

FIG. 11 illustrates an example of a charging process. As illustrated in FIG. 11, the charging unit 23 calculates the price for each service used by each project from the usage period in the service use information table 14 and the unit price in the unit-price table 15 (operation S21).

The charging unit 23 adds up the usage prices of services used by each of the projects (operation S22). The office organization code associated with a project is identified from the project table 13, and the organization associated with the office organization code is identified from the organization table 12, and the organization is charged (operation S23).

In the above manner, since the charging unit 23 identifies the office organization code associated with the project, charging for using services may be reliably performed. This enables to select a payer for the used service flexibly. For example, in the above embodiments, when “SABURO FUJI” use a service, a payer for the used service is not always the organization of the office organization code “6789” to which “SABURO FUJI” directly belongs. In other words, the payer for the used service is selected or switched based on which project is selected when “SABURO FUJI” uses the service. More specifically, when “SABURO FUJI” uses the service as a member of “PROJECT X”, it is determined that the payer for the used service is the organization of the office organization code “6789”. On the contrary, when “SABURO FUJI” uses the service as a member of “PROJECT A”, it is determined that the payer for the used service is the organization of the office organization code “1234”.

For example, the project and the office organization code are associated with each other in the project table 13, and the office organization code and the organization are associated with each other in the organization table 12. The charging unit 23 calculates the usage price of a service used by the project. The charging unit 23 identifies the office organization code of the project by using the project table 13 and identifies the organization associated with the identified office organization code by using the organization table 12. The charging unit 23 charges the identified organization for using the service. Accordingly, the project creating process enables to select a payer for the used service flexibly. In addition, even if a change is made in the organization, the charging management apparatus 1 may charge the organization without correcting the payer of the charge.

In the project creating process, the project managing unit 22 displays a list of office organization codes and names of organizations including the organization to which the logged-in user belongs by referring to the organization table 12. The project managing unit 22 registers the office organization code selected by the logged-in user in the project table 13 as the office organization code of a newly created project. Accordingly, the creator of the project, for example, the logged-in user, may easily associate the office organization code with the project.

The agent and usable service are registered in the project table 13, and the project managing unit 22 receives a change in the usable service, made by an agent, and updates the project table 13. Accordingly, even if the manager of the project is absent, the usable service may be changed, and the charging management apparatus 1 may handle with an urgent use of a service that is not registered.

By realizing the configuration of the above charging management apparatus 1 with software, a charging management program having the same or similar functions is provided.

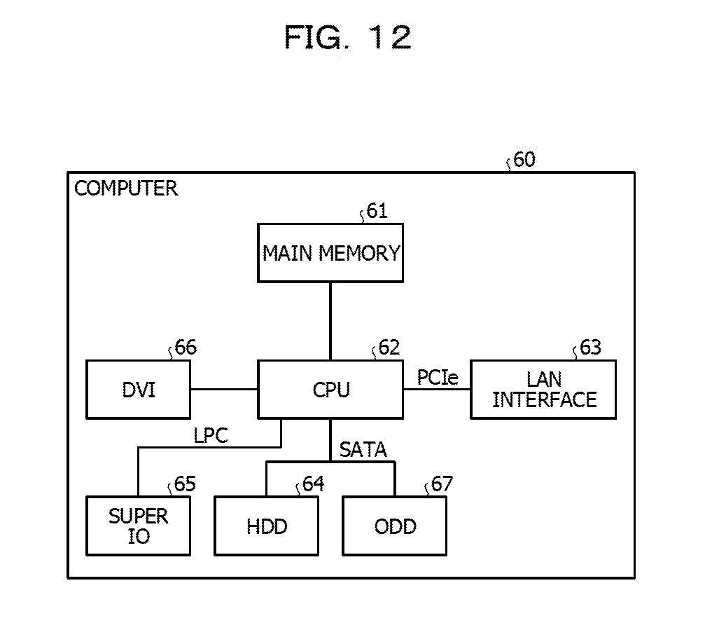

FIG. 12 illustrates an example of a hardware configuration of a computer. The computer illustrated in FIG. 12 may execute the above charging management program. As illustrated in FIG. 12, a computer 60 includes a main memory 61, a CPU 62, a local area network (LAN) interface 63, and a hard disk drive (HDD) 64. The computer 60 includes a super input output (JO) 65, a digital visual interface (DVI) 66, and an optical disk drive (ODD) 67.

The main memory 61 is a memory that stores programs, results obtained during the execution of the programs, and the like. The CPU 62 is a central processing unit that reads and executes the programs from the main memory 61. The CPU 62 includes a chipset including a memory controller.

The LAN interface 63 is an interface for coupling the computer 60 to another computer via a LAN. The HDD 64 is a disk device that stores programs and data, and the super IO 65 is an interface for coupling input devices such as a mouse and a keyboard. The DVI 66 is an interface for coupling a liquid crystal display apparatus, and the ODD 67 is a device for reading and writing data from and to a DVD.

The LAN interface 63 is coupled to the CPU 62 by PCI express (PCIe), and the HDD 64 and the ODD 67 are coupled to the CPU 62 by Serial Advanced Technology Attachment (SATA). The super IO 65 is coupled to the CPU 62 by the Low Pin Count (LPC) bus.

The charging management program to be executed by the computer 60 is stored in a DVD and read by the ODD 67 from the DVD to be installed in the computer 60. For example, the charging management program is stored in a database and the like of another computer system coupled through the LAN interface 63 and read from the database to be installed in the computer 60. The installed charging management program is stored in the HDD 64 and read by the main memory 61 to be executed by the CPU 62.

A service may be provided within a company or to affiliated companies that belong to the same group. For example, the charging management apparatus may manage charging if a service out of the company is provided.

The office organization code may be used for charging management. For example, the charging management apparatus may use a code that is other than the office organization code and that may be associated with the payer of the charge.

The charging management may be applied to a service for lending a computer resource such as a virtual machine, a physical machine, or a storage, a code hosting service, or a service that provides a tool (software). For example, the charging management apparatus may manage the price for using another service.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a memory configured to store information associating, for each project of one or more projects having a flat structure, the project with an organization that is selected from a plurality of organizations having a hierarchical structure, at least one of one or more members of the project belonging to the selected organization; and
a processor coupled to the memory and the processor configured to:
charge, when a first service is provided for a first project, a first organization for the provided first service, the first organization being associated with the first project by the stored information.

2. The information processing apparatus according to claim 1, wherein
for each organization of the plurality of organizations, the organization is associated with an office organization code in the stored information, and
for each project of the one or more projects, the project is associated with the office organization code in the stored information.

3. The information processing apparatus according to claim 2, wherein
the office organization code is settable so that the office organization code is not changed when an organization associated with the office organization code is changed.

4. The information processing apparatus according to claim 1, wherein
the processor is further configured to associate, when a second project is created, the second project with a second organization selected from organizations that includes a third organization and a lower organization of the third organization in the hierarchical structure, a person who creates the second project belonging to the third organization.

5. The information processing apparatus according to claim 1, wherein
for each project of the one or more projects, the project is associated with one or more services that are usable for the project, a person who creates the project being capable of changing the one or more services.

6. The information processing apparatus according to claim 5, wherein
for each project of the one or more projects, the project is associated with an agent of a person who creates the project, the agent being capable of changing the one or more services.

7. The information processing apparatus according to claim 5, wherein
the one or more services includes at least one of a service for lending a virtual machine, a service for lending a physical machine, a service for lending a storage, a code hosting service, and a service that provides a tool.

8. An information processing method comprising:
in the memory, storing information associating, for each project of one or more projects having a flat structure, the project with an organization that is selected from a plurality of organizations having a hierarchical structure, at least one of one or more members of the project belonging to the selected organization; and
charging, when a first service is provided for a first project, a first organization for the provided first service, the first organization being associated with the first project by the stored information.

9. A non-transitory computer-readable storage medium including computer program instructions, which when executed by an information processing apparatus, cause the information processing apparatus to:
in the memory, store information associating, for each project of one or more projects having a flat structure, the project with an organization that is selected from a plurality of organizations having a hierarchical structure, at least one of one or more members of the project belonging to the selected organization; and
charge, when a first service is provided for a first project, a first organization for the provided first service, the first organization being associated with the first project by the stored information.
